(19) United States
(12) Patent Application Publication
(10) Pub. No.: US 2012/0206426 A1
(43) Pub. Date: Aug. 16, 2012

(54) IMAGE DISPLAY APPARATUS AND CONTROL METHOD THEREOF

(75) Inventors: Eito Sakakima, Tokyo (JP); Masaki Tamura, Kawasaki-shi (JP)

(73) Assignee: CANON KABUSHIKI KAISHA, Tokyo (JP)

(21) Appl. No.: 13/358,666

(22) Filed: Jan. 26, 2012

(30) Foreign Application Priority Data
Feb. 15, 2011 (JP) 2011-030219
Dec. 28, 2011 (JP) 2011-289897

(51) Int. Cl. G09G 3/36; G09G 5/10

(52) U.S. Cl. 345/207; 345/102; 345/101

(57) ABSTRACT

An image display apparatus, comprises a display unit; a luminance sensor arranged in plural portions of the display unit, each luminance sensor having temperature characteristics; a temperature sensor arranged in plural portions of the display unit; an acquisition control unit configured to acquire a temperature value from the temperature sensor and a luminance value from the luminance sensor; a determination unit configured to determine a frequency for acquiring the temperature value from the temperature sensor based on an orientation of the display unit or a display setting; a correction unit configured to correct the luminance value acquired from the luminance sensor by using the temperature value acquired from the temperature sensor; and an image processing unit configured to control luminance of the display unit by using the luminance value corrected by the correction unit as a target luminance value.

### BACKGROUND OF THE INVENTION

1. Field of the Invention

The present invention relates to an image display apparatus that displays video signals.

2. Description of the Related Art

Recently, liquid display apparatuses have become mainstream in image display apparatuses. In a liquid crystal display apparatus, a light source (hereinafter referred to as the “back light”) emits light from the rear face of a liquid crystal panel and transmitted light is observed, thereby displaying an image.

With respect to the liquid crystal panel, which is an element constituting the liquid crystal display apparatus, there is a correlation between the liquid crystal driving amount and the temperature of the liquid crystal panel. The light-emitting diode (hereinafter referred to as the “LED”), which is becoming a mainstream in back lights, a luminance sensor mounted for performing feedback control on luminance and colors, and the like also have temperature characteristics. Therefore, in order to display stable images at any temperature, it is necessary to change the driving state of the liquid crystal panel according to the temperature.

In order to solve the problems described above, in the technique disclosed in Japanese Patent Laid-Open No. 2008-046289, the liquid crystal driving amount is controlled by using temperature rising characteristics of the liquid crystal panel that are preset in the liquid crystal display apparatus. Specifically, the current temperature and the time elapsed after start-up of the liquid crystal display apparatus are measured, and the liquid crystal driving amount is decided based on the elapsed time and the temperature rising characteristics.

However, in the technique of Japanese Patent Laid-Open No. 2008-046289 stated above, since the liquid crystal driving amount is controlled by using only the temperature rising characteristics associated with a specific state which is defined in terms of elapsed time after start up, there may be cases where a desired effect cannot be achieved if the apparatus is not in that specific state. Some liquid crystal display apparatus can be changed into several different states through an operation by the user.

FIG. 16 shows an example case in which the orientation of the screen of the display apparatus is changed by the user's operation. As illustrated by landscape orientation (wider-than-tall orientation) 1601 and portrait orientation (taller-than-wide orientation) 1602 shown in FIG. 16, the temperature rising characteristics of the display apparatus may differ depending on the installation orientation thereof. Also, FIG. 17 shows states during single screen display and multi-screen display. As shown in a multi-screen 1702 in FIG. 17, when images subjected to mutually different image processing are respectively displayed in two display areas, the temperature rising characteristics may change according to the performed image processing.

In addition, the temperature rising characteristics may differ among partial areas in the screen. For example, the power supply circuit mounted to the liquid crystal display apparatus radiates a large amount of heat, and thus it is considered that the temperature rises more markedly in the vicinity of the power supply circuit than in other areas.

As described above, in the case where the temperature rising characteristics differ among areas in the screen, and change according to the installation orientation of the screen or the state of the display screen (single screen display, multi-screen display or the like), it is important to accurately acquire the temperature condition for each area of the screen of the display apparatus and perform drive control according to the temperature rising characteristics suitable for the area of the screen or the state of the screen.

In conventional techniques, no consideration is given to the case where the temperature characteristics differ among areas in the screen of the display apparatus, and thus there are cases in which it is impossible to display an image correctly and stably over the entire screen.

### SUMMARY OF THE INVENTION

The present invention has been made in consideration of the aforementioned problems, and realizes a display control technique with which luminance of a display screen can be appropriately controlled according to the temperature characteristics of each area of the screen of an image display apparatus.

In order to solve the aforementioned problems, the present invention provides an image display apparatus, comprising: a display unit; a luminance sensor arranged in plural portions of the display unit, each luminance sensor having temperature characteristics; a temperature sensor arranged in plural portions of the display unit; an acquisition control unit configured to acquire a temperature value from the temperature sensor and a luminance value from the luminance sensor; a determination unit configured to determine a frequency for acquiring the temperature value from the temperature sensor based on an orientation of the display unit or a display setting; a correction unit configured to correct the luminance value acquired from the luminance sensor by using the temperature value acquired from the temperature sensor; and an image processing unit configured to control luminance of the display unit by using the luminance value corrected by the correction unit as a target luminance value.

In order to solve the aforementioned problems, the present invention provides a control method of an image display apparatus having a display unit, a luminance sensor arranged in plural portions of the display unit, each luminance sensor having temperature characteristics, and a temperature sensor arranged in plural portions of the display unit, the method comprising the steps of: acquiring a temperature value from the temperature sensor and acquire a luminance value from the luminance sensor; determining a frequency for acquiring the temperature value from the temperature sensor based on an orientation of the display unit or a display setting; correcting the luminance value acquired from the luminance sensor by using the temperature value acquired from the temperature sensor; and controlling luminance of the display unit by using the luminance value corrected in the correcting step as a target luminance value.

According to the present invention, it is possible to appropriately control luminance of the display screen according to the temperature characteristics of each area of the screen of an image display apparatus.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image display apparatus according to an embodiment of the invention.

FIG. 2 is a block diagram illustrating detailed functions of the blocks shown in FIG. 1.

FIG. 3 is a flowchart illustrating processing performed when the image display apparatus is started up according to Embodiment 1.

FIG. 4 is a diagram illustrating the layout of sensors in a display panel when the display panel is installed in a landscape orientation.

FIGS. 5A to 5D are diagrams illustrating temperature inside the display panel when the display panel is installed in the landscape orientation.

FIGS. 6A to 6C are diagrams illustrating processing for deciding a sensor value acquisition frequency when the display panel is installed in the landscape orientation.

FIG. 7 is a diagram illustrating the layout of sensors in the display panel when the display panel is installation in a portrait orientation.

FIGS. 8A to 8D are diagrams illustrating temperature inside the display panel when the display panel is installed in the portrait orientation.

FIG. 9 is a diagram illustrating frequencies for acquiring values of the sensors when the display panel is installed in the portrait orientation.

FIG. 10 is a flowchart illustrating processing performed for transitioning to a steady state of the image display apparatus according to Embodiment 1.

FIG. 11 is a flowchart illustrating luminance feedback control processing performed based on sensor values.

FIG. 12 is a flowchart illustrating processing performed when an image display apparatus is started up according to Embodiment 2.

FIG. 13 is a diagram illustrating the layout of sensors in a case where each screen has a different luminance value in a multi-screen display mode.

FIGS. 14A to 14D are diagrams illustrating temperature of the display panel in a case where each screen has a different luminance value in the multi-screen display mode.

FIG. 15 shows sensor value acquisition frequencies in a case where each screen has a different luminance value in the multi-screen display mode.

FIG. 16 is a diagram showing example installation orientations of the image display apparatus.

FIG. 17 is a diagram showing example display settings of the image display apparatus.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments. Also, parts of the embodiments to be described later may be properly combined.

The image display apparatus of the present invention can perform luminance control according to the temperature state of the display unit by changing the acquisition frequencies of the sensor values of at least temperature sensors, from among luminance sensors and temperature sensors arranged in plural portions of the display unit, in accordance with temperature characteristics of each area of the screen of the image display apparatus, thereby displaying images at appropriate luminance. Here, the temperature characteristics of each area of the screen of the image display apparatus refers to the difference in the temperature rising rates among areas of the display unit, which depend on the settings of the image display apparatus and the elapsed time after start up of the apparatus.

### Embodiment 1

As Embodiment 1, an image display apparatus will be described that performs feedback control for setting the luminance of the display unit to a target luminance value, by using luminance information of the display unit detected by the luminance sensors. Here, the luminance sensor mounted to the image display apparatus has temperature characteristics, and thus the value detected by the luminance sensor varies depending on the ambient temperature. Therefore, the image display apparatus also includes a temperature sensor to correct the values detected by the luminance sensor. In Embodiment 1, the sensor value acquisition frequency is changed between when the image display apparatus is installed in the portrait orientation and when it is installed in the landscape orientation.

### Configuration of Apparatus

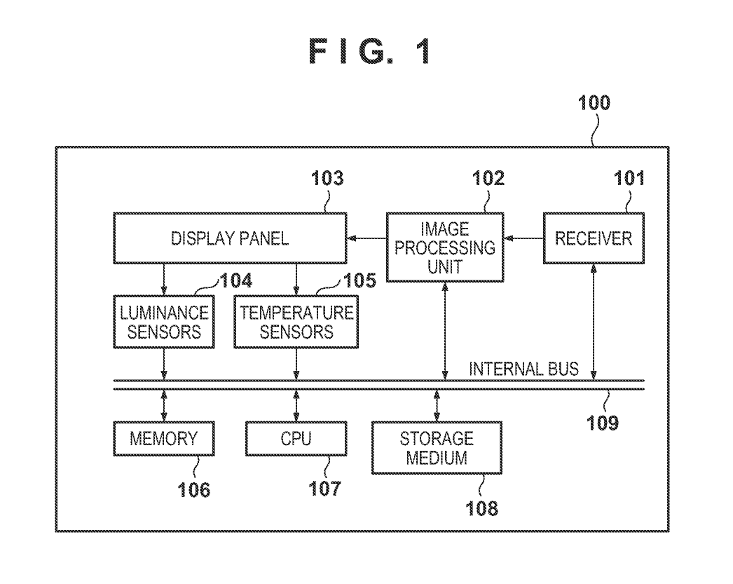

The configuration of the image display apparatus will be described below with reference to FIG. 1.

In FIG. 1, a receiver 101 receives video signals input to an image display apparatus 100. The video signal is input from a video input terminal such as a Display Port (hereinafter referred to as the “DP”), a Digital Visual Interface (hereinafter referred to as the “DVI”), or a High-Definition Multimedia Interface (hereinafter referred to as the “HDMI”).

An image processing unit 102 performs various types of image processing on a video signal received by the receiver 101. Specific examples of such image processing includes changing luminance, contrast, input resolution, and the like. Data obtained by the processing performed by the image processing unit 102 is transferred to a display panel 103 described later to be actually presented to a user.

The display panel 103 has the function of displaying video signals input to the image display apparatus 100, and thereby presenting the video signals to the user. A specific example of the display panel 103 is a liquid crystal display panel. The liquid crystal display panel displays video images by projecting light from the rear face of the liquid crystal screen with a back light, and adjusting the liquid crystal transmittance. In the present embodiment, a liquid crystal display panel is assumed to be used as the display panel 103. The display panel 103 is assumed to include a liquid crystal panel and a back light.

Luminance sensors 104 are arranged at plural portions so as to be adjacent to the display panel 103, and measure luminance values of the display panel 103. The luminance values measured by the luminance sensors 104 are used in processing for adjusting the luminance of an image presented on the display panel 103 to the target luminance value. Although the luminance sensors 104 are depicted as a single block in FIG. 1, plural luminance sensors 104 are mounted inside the image display apparatus 100 in a distributed manner.

Temperature sensors 105 are arranged at plural portions so as to be adjacent to the display panel 103 similarly to the luminance sensors 104, and measure temperature around the luminance sensors 104. The luminance sensors 104 have temperature characteristics as described above, and their values vary depending on the ambient temperature. Accordingly, an actual luminance value of the display panel 103 is calculated by measuring the ambient temperature with the temperature sensors 105, and correcting the sensor values measured by the luminance sensors 104. Similarly to the luminance sensors 104, a plurality of temperature sensors 105 are mounted inside the image display apparatus 100 in a distributed manner.

A memory 106 is used for temporarily storing a variety of data. For example, data temporarily stored includes a result of calculation performed when a sensor value measured by the luminance sensor 104 is corrected by the temperature sensor 105 and intermediate data of such calculation, or a program that is executed by a CPU 107 as shown in a flowchart described later.

The CPU 107 is an arithmetic processing device that executes various types of processing for the image display apparatus 100. The CPU 107 executes sensor value acquisition processing, sensor value acquisition frequency determination processing, and the like, which are described later.

A storage medium 108 records therein a variety of information relating to the image display apparatus 100. User setting information relating to image processing performed by the image display apparatus 100 and the installation orientation of the display panel 103 are accumulated and stored. In the case where the image display apparatus 100 has a gyroscope or the like, the orientation of the display panel 103 is automatically detected, and accumulated and stored in the storage medium 108. Information on the pattern of temperature rising inside the image display apparatus 100 is also stored.

The hardware blocks are connected to each other by an internal bus 109, and data is exchanged therebetween via the internal bus 109.

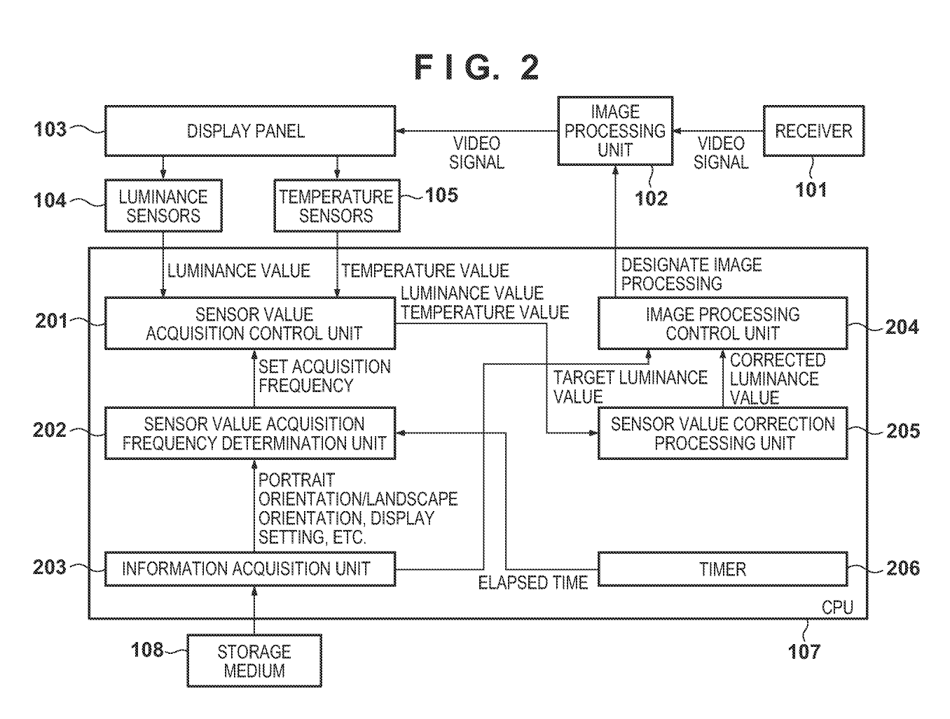

Next, the function of each block in FIG. 1 will be described with reference to FIG. 2. Note that the function of each block shown in FIG. 2 is basically realized by the CPU 107 of FIG. 1.

In FIG. 2, a sensor value acquisition control unit 201 acquires sensor values measured by the luminance sensors 104 and the temperature sensors 105. Sensor values are acquired from the sensors periodically. Also, a plurality of luminance sensors 104 and temperature sensors 105 are mounted inside the image display apparatus 100, and the values of the sensors are acquired when necessary.

A sensor value acquisition frequency determination unit 202 determines, based on a variety of information of the image display apparatus 100 and the elapsed time after start up of the image display apparatus 100, a frequency for acquiring sensor values from the plurality of luminance sensors 104 and temperature sensors 105 mounted to the image display apparatus 100. Although sensor values from the plurality of luminance sensors 104 and the plurality of temperature sensors 105 are acquired at the same acquisition frequency in the present embodiment, the sensor values may be acquired at different acquisition frequencies. The determined sensor value acquisition frequency is notified to the sensor value acquisition control unit 201, and the sensor value acquisition control unit 201 acquires sensor values from the luminance sensors 104 and the temperature sensors 105 at the designated acquisition frequency.

Note that it is also possible that sensor values from the plurality of luminance sensors 104 are acquired at a fixed frequency, and the sensor value acquisition frequency determination unit 202 determines only the frequency for acquiring sensor values from the plurality of temperature sensors 105 mounted to the image display apparatus 100, based on a variety of information of the image display apparatus 100 and the elapsed time after start up of the image display apparatus 100.

An information acquisition unit 203 performs processing for acquiring a variety of information from the storage medium 108. Information read out from the information acquisition unit 203 includes the installation orientation of the display panel 103 of the image display apparatus 100, information relating to image processing applied to the image display apparatus 100, information on the pattern of temperature rising inside the image display apparatus 100, and the like. The information relating to image processing also includes the target luminance value of the image display apparatus 100 set by the user. The variety of information read out by the information acquisition unit 203 is transferred to the sensor value acquisition frequency determination unit 202, and the sensor value acquisition frequency determination unit 202 determines the sensor value acquisition frequency based on the transferred information.

An image processing control unit 204 controls the image processing unit 102 in FIG. 1, and performs various types of image processing on a video signal input to the image display apparatus 100. The image processing control unit 204 executes image processing so as to achieve the target luminance value based on a luminance value corrected by a sensor value correction processing unit 205 to be described later. Specifically, in the display panel 103 in FIG. 1, the image processing control unit 204 notifies a signal controlling the back light via the image processing unit 102. If the current luminance value is lower than the target luminance value, the image processing control unit 204 performs processing for increasing the luminance by increasing back light output, and if the current luminance value is higher than the target luminance value, it performs processing for decreasing back light output.

The sensor value correction processing unit 205 corrects a luminance value acquired by the sensor value acquisition control unit 201, based on the temperature value acquired by the sensor value acquisition control unit 201. Since the luminance sensor 104 is a device having temperature characteristics, the sensor value correction processing unit 205 corrects the sensor values of the luminance sensors 104 based on the temperature values measured by the temperature sensors 105. The corrected luminance values are transferred to the image processing control unit 204, and used in the above-described image processing performed by the image processing control unit 204.

A timer 206 measures the elapsed time after start up of the image display apparatus 100. The measured elapsed time is transferred to the sensor value acquisition frequency determination unit 202, and the sensor value acquisition frequency determination unit 202 determines the sensor value acquisition frequency based on the elapsed time and a value read out from the information acquisition unit 203.

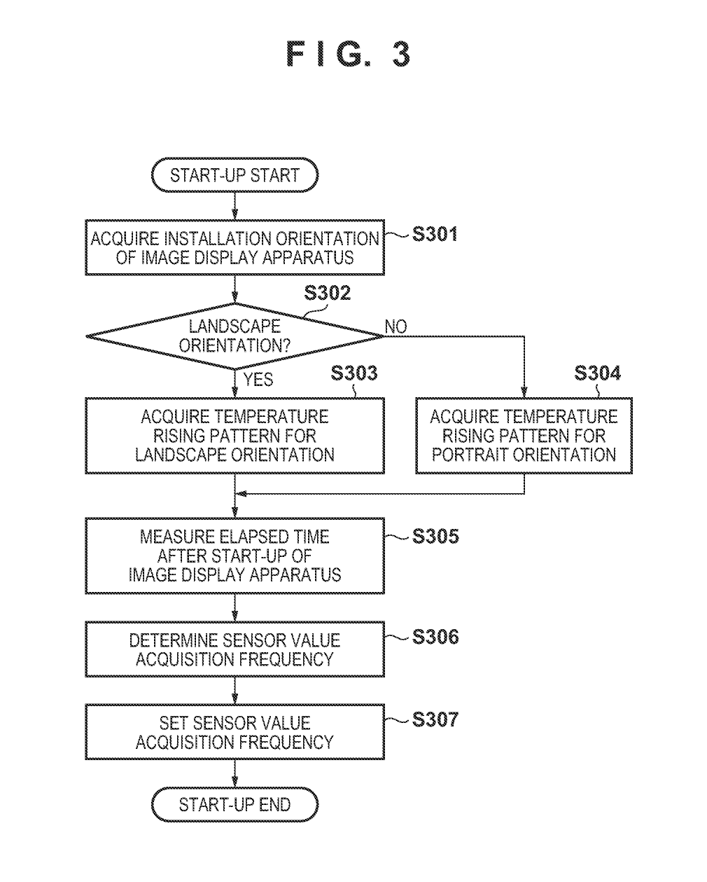

Next, processing performed when the image display apparatus 100 is started up in Embodiment 1 will be described with reference to FIG. 3. FIG. 3 illustrates processing performed from after power is supplied to the image display apparatus 100, until a frequency for acquiring sensor values is determined for each sensor and the determined acquisition frequency is set in the sensor value acquisition control unit 201. Note that the processing described below is realized by the CPU 107 executing programs recorded in the storage medium 108 as the functional blocks in FIG. 2.

In FIG. 3, after start up of the image display apparatus 100, in step S301, the information acquisition unit 203 reads out a variety of information of the image display apparatus 100. Here, information representing whether the image display apparatus 100 is installed in the portrait orientation or in the landscape orientation is read out.

In step S302, the CPU 107 determines the installation orientation of the image display apparatus 100 based on the information read out in step S301. If the installation orientation is the landscape orientation, the procedure proceeds to step S303, and if the installation orientation is the portrait orientation, the procedure proceeds to step S304.

A case in which the image display apparatus 100 is installed in the landscape orientation will be described below.

In step S303, the information acquisition unit 203 acquires, from the storage medium 108, information on a temperature rising pattern when the image display apparatus 100 is installed in the landscape orientation.

In step S305, the CPU 107 measures the elapsed time from start up of the image display apparatus 100, using the timer 206.

In step S306, the sensor value acquisition frequency determination unit 202 determines a sensor value acquisition frequency based on the elapsed time measured in step S305 and the temperature rising pattern information acquired in step S303.

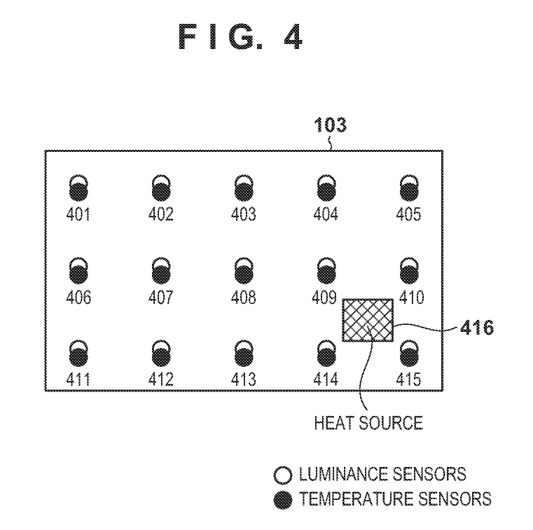

Here, processing for determining a sensor value acquisition frequency, which is executed in step S306, will be described with reference to FIG. 4. FIG. 4 schematically illustrates the layout of the luminance sensors 104 and the temperature sensors 105 in the display panel 103. FIG. 4 shows a state in which fifteen each of the luminance sensors 104 and the temperature sensors 105 are arranged on the display panel. One each of the luminance sensor 104 and the temperature sensor 105 are arranged at the same position on the display panel 103, and the sets of sensors are arranged equally spaced at the portions indicated by 401 to 415 in FIG. 4.

The image display apparatus 100 includes several elements serving as a heat source 416, as shown in FIG. 4. The heat source 416 is, for example, a power supply device of the image display apparatus 100, the CPU 107 in FIG. 1, and the like. In the image display apparatus 100, it is considered that the shorter the distance from an area to the heat source 416, the more precipitously the temperature rises in the area after start up of the image display apparatus 100, and that the longer the distance from the area to the heat source 416, the more gently the temperature rises in the area.

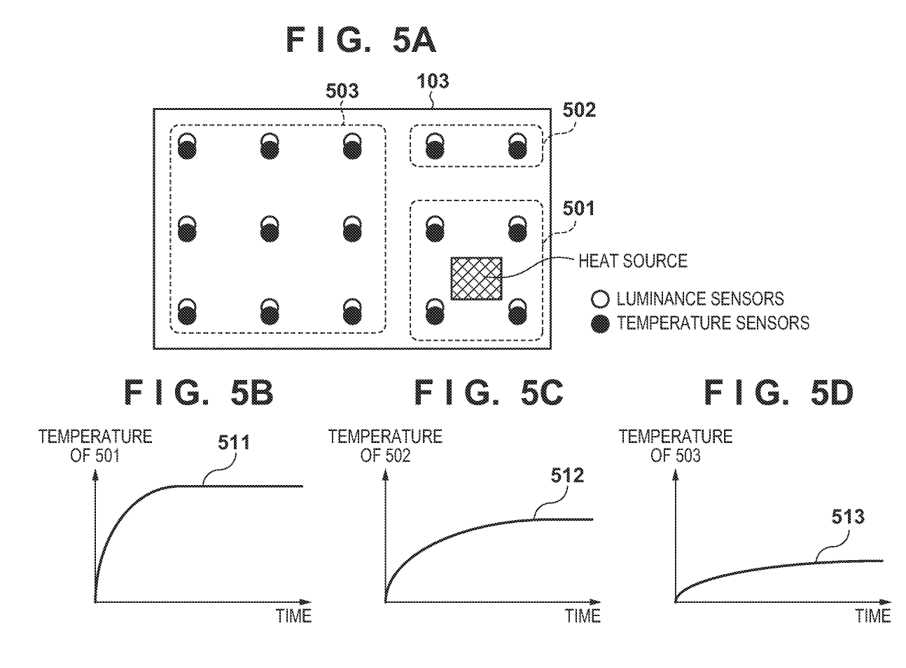

Next, temperature change inside the image display apparatus 100 will be described with reference to FIGS. 5A to 5D. FIGS. 5A to 5D illustrate temperature rising patterns of a plurality of areas inside the image display apparatus 100. As shown in FIG. 5A, the display panel 103 is divided into three areas, namely, an area 501, an area 502 and an area 503, according to the temperature rising rate. The area 501 is an area closest to the heat source, where the temperature changes the most acutely. The area 503 is considered to be the area that is influenced least by the heat source, where the temperature changes the most gently. Temperature change in the area 502 is between that in the area 501 and that in the area 503. The temperature rising patterns in the area 501, the area 502 and the area 503 are respectively shown in a graph 511, a graph 512 and a graph 513 of FIG. 5B to 5D. These temperature rising patterns are recorded in advance in the storage medium 108. Based on FIGS. 5A to 5D, it is possible, in the area 501 where the temperature changes acutely, to accurately obtain the temperature at different times by measuring the temperature more frequently.

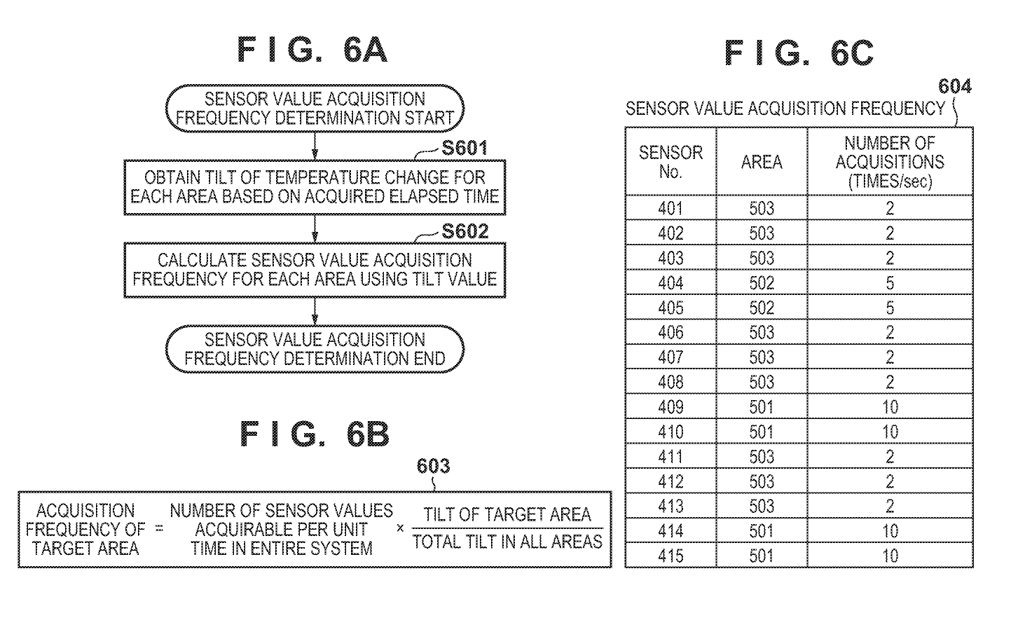

Here, processing in which the sensor value acquisition frequency determination unit 202 determines the frequency for acquiring sensor values from the sensors will be described with reference to FIGS. 6A to 6C.

In FIG. 6A, in step S601, the elapsed time acquired in step S305 in FIG. 3 is used to obtain a tilt in each area at that elapsed time. It is possible to determine that the more precipitous the tilt at a point, the higher the temperature rising rate at the point, and thus in step S602, the tilt is used to determine the sensor value acquisition frequency for each area. FIG. 6B indicates a calculation formula for determining the acquisition frequency. The calculation formula in FIG. 6B uses the tilt as a weight, and allocates acquisition frequencies from the highest sensor value acquisition frequency that can be achieved in the entire system, starting from the area having the largest tilt. FIG. 6C shows sensor value acquisition frequencies of the sensors determined by the flowchart shown in FIG. 6A, and the sensors belonging to the area 501 in FIG. 5A have the highest number of sensor value acquisitions per unit time. Note that the calculation formula in FIG. 6B is an example, and any calculation formula may be used as long as it is possible to allocate a larger number of sensor value acquisitions to areas where the temperature changes precipitously.

In step S307, the sensor value acquisition frequencies determined in step S306 are set in the sensor value acquisition control unit 201. The sensor value acquisition control unit 201 acquires sensor values from the luminance sensors 104 and the temperature sensors 105 according to the set acquisition frequencies.

As described above, the acquisition frequency when the image display apparatus 100 is installed in the landscape orientation is determined for each sensor, and sensor values are acquired according to the determined acquisition frequency. Since the acquisition frequency is set to a high value for an area where the temperature changes acutely, it is possible to accurately obtain the temperature state, and thus it is possible to perform accurate image processing feedback control.

Similarly, in step S302 in FIG. 3, in the case where the installation orientation of the image display apparatus 100 is determined to be the portrait orientation, in step S304, the temperature rising pattern for the portrait orientation is read out by the information acquisition unit 203.

Processing performed in the case of the portrait orientation in step S304 onward is the same as that performed in the case of the landscape orientation described above.

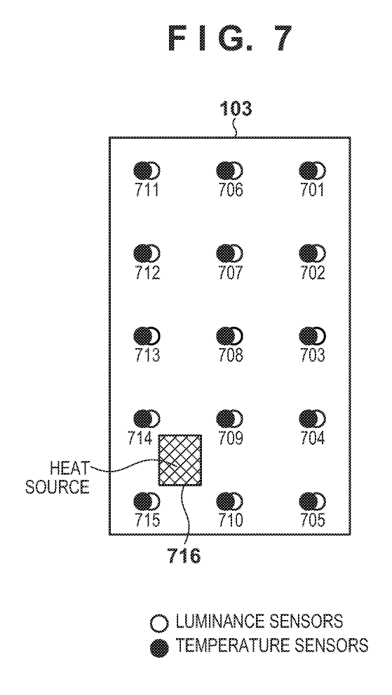

Next, processing for determining sensor value acquisition frequency performed in step S306 when the image display apparatus 100 is installed in the portrait orientation will be described with reference to FIG. 7. FIG. 7 schematically illustrates the layout of the luminance sensors 104 and the temperature sensors 105 in the display panel 103, which is obtained by rotating the display panel 103 installed in the landscape orientation shown in FIG. 4 by 90 degrees to the right.

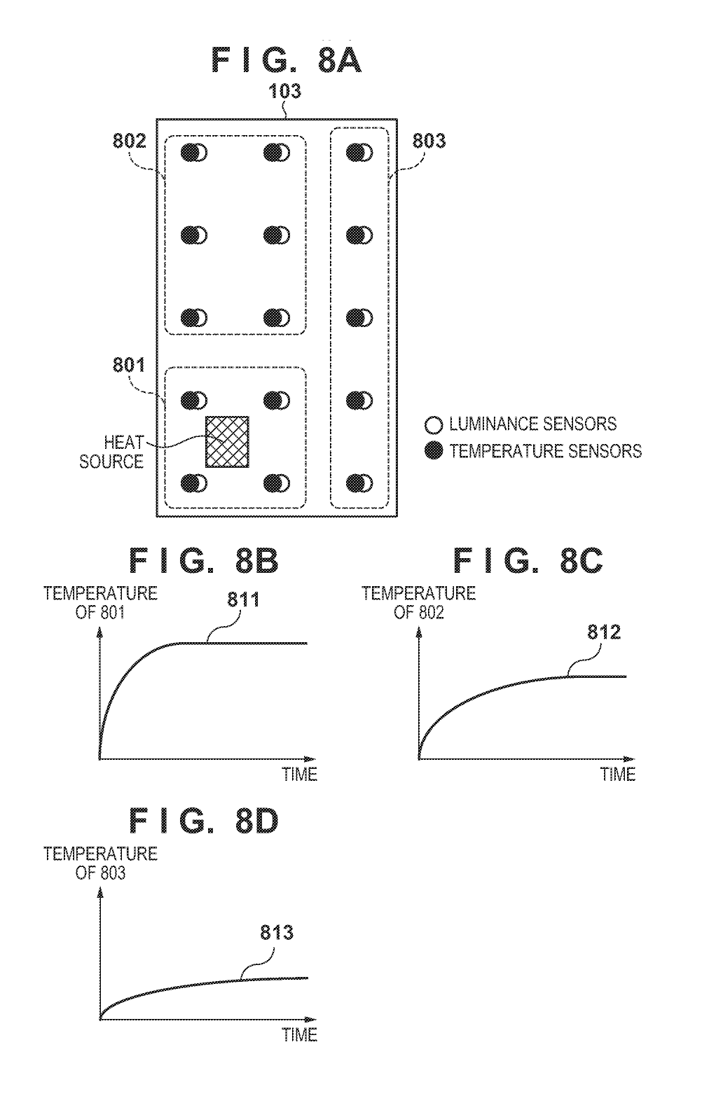

First, temperature change inside the image display apparatus 100 will be described with reference to FIGS. 8A to 8D. FIGS. 8A to 8D illustrate temperature rising patterns of a plurality of areas inside the image display apparatus 100. As shown in FIG. 8A, the display panel 103 is divided into three areas, namely, an area 801, an area 802 and an area 803, according to the temperature rising rate. The area 801 is an area closest to the heat source, where the temperature changes the most acutely. The area 803 is considered to be the area that is influenced least by the heat source, where the temperature changes the most gently. Temperature change in the area 802 is between that in the area 801 and that in the area 803. The temperature rising patterns in the area 801, the area 802 and the area 803 are respectively shown in a graph 811, a graph 812 and a graph 813 of FIG. 8B to 8D. These temperature rising patterns are recorded in advance in the storage medium 108. Based on FIGS. 8A to 8D, it is possible, in the area 801 where the temperature changes acutely, to accurately obtain the temperature at different times by measuring the temperature more frequently.

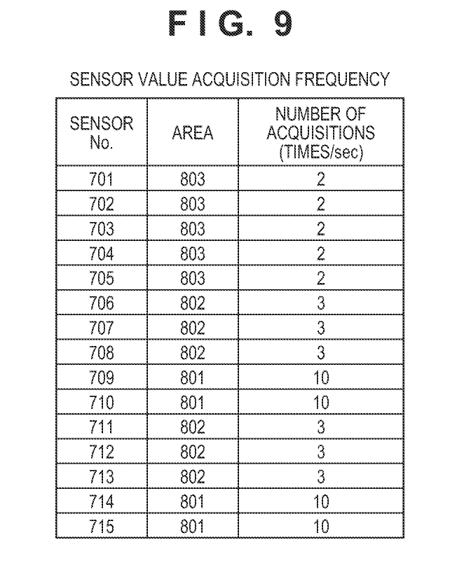

Then, the sensor value acquisition frequency determination unit 202 determines sensor value acquisition frequencies for the sensors based on the sensor value acquisition frequencies shown in FIG. 9. In FIG. 9, the sensors belonging to the area 801 in FIG. 8A have the highest number of sensor value acquisitions per unit time.

As described above, it is possible to determine the sensor value acquisition frequency, while taking the installation orientation of the image display apparatus 100 into account, when the image display apparatus 100 is started up. In this manner, even if the installation orientation of the image display apparatus 100 is changed, it is possible to constantly measure accurate temperature, which makes it possible to perform feedback control for displaying an image at accurate luminance.

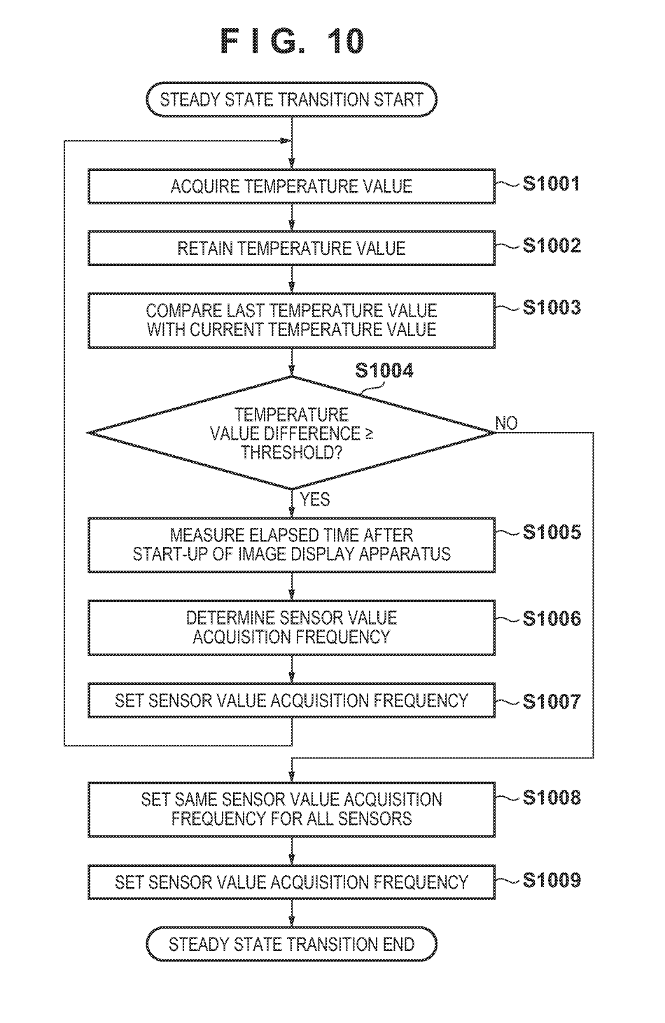

Next, processing for changing the sensor value acquisition frequency according to the elapsed time after start up that is performed by the CPU 107 will be described with reference to FIG. 10. FIG. 10 illustrates processing in which the temperature rising change transitions to a steady state after start-up of the image display apparatus 100, and thus the same acquisition frequency is set for all sensors.

In FIG. 10, in step S1001, the sensor value acquisition control unit 201 acquires sensor values from the temperature sensors 105.

In step S1002, the temperature values acquired in step S1001 are stored in the memory 106. Here, a plurality of acquired temperature values are stored in time series.

In step S1003, the temperature value acquired last time is compared with the temperature measured this time.

In step S1004, if the difference between the temperature values is greater than or equal to a threshold, the elapsed time after start-up of the image display apparatus 100 is measured in step S1005. Thereafter, in step S1006, the sensor value acquisition frequency is again determined according to the current elapsed time and the installation orientation of the image display apparatus 100.

In step S1007, a new acquisition frequency is set in the sensor value acquisition control unit 201. Note that the processing from steps S1005 to S1007 in FIG. 10 is similar to that from steps S305 to S307 in FIG. 3, and thus description thereof will not be given here.

If a difference between the temperature values is less than the threshold in step S1004, the same sensor value acquisition frequency is set to all sensors in step S1008. Consequently, the sensor value acquisition frequency in a state in which the image display apparatus 100 is in a steady state, that is, in a state in which there is little change in temperature, is determined. In step S1009, that acquisition frequency is set in the sensor value acquisition control unit 201, and after that, the image processing control unit 204 performs acquisition of sensor values according to the set acquisition frequency and luminance feedback control.

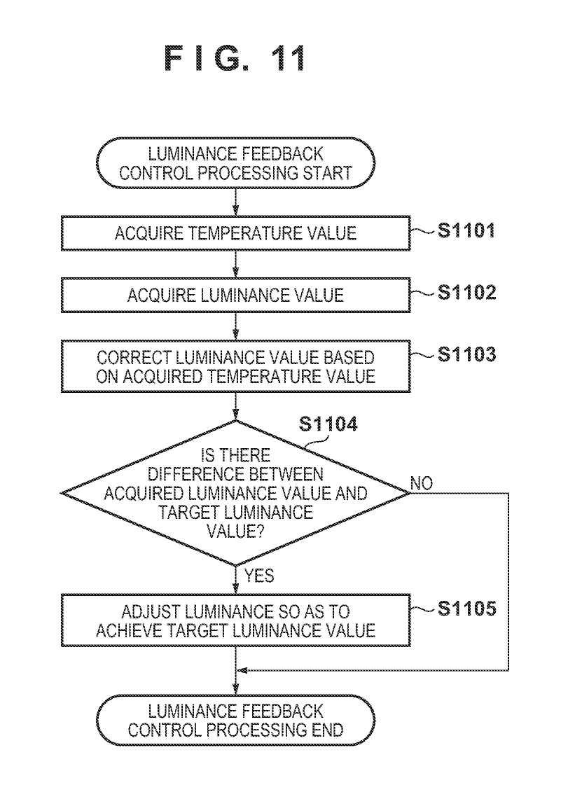

Next, processing in which the image processing control unit 204 performs luminance feedback control by using sensor values will be described with reference to FIG. 11. FIG. 11 illustrates feedback control processing focusing on a specific sensor. Note that the processing illustrated in FIG. 11 is basically executed in a state in which the image display apparatus 100 has been started up and input video is being displayed.

In steps S1101 and S1102, the sensor value acquisition control unit 201 acquires temperature value and luminance value from the temperature sensor 105 and the luminance sensor 104, respectively.

In step S1103, the sensor value correction processing unit 205 corrects the luminance value acquired in step S1102, based on the temperature values acquired in step S1101. The luminance value is corrected in step S1103 because the luminance value is influenced by the temperature at the time of measurement due to the temperature characteristics of the luminance sensor 104.

In step S1104, the image processing control unit 204 determines whether the luminance value corrected in step S1103 is different from the preset target luminance value, and if different, the procedure proceeds to step S1105.

In step S1105, the image processing control unit 204 adjusts the luminance via the image processing unit 102 so as to display input video at the target luminance value. Specifically, the image processing control unit 204 performs luminance correction processing so as to achieve the target luminance value, and controls illuminance of the back light of the display panel 103 via the image processing unit 102.

By performing the above-described processing steadily, it is possible to constantly display input video at the target luminance value.

With Embodiment 1 described above, accurate temperature measurement becomes possible that takes change in temperature rising in the display panel 103 due to difference in the installation orientation of the image display apparatus 100 into account. As a result, sensor values from the luminance sensors 104 can be corrected with high accuracy, and it becomes possible to perform appropriate feedback control on the luminance of the display panel 103.

### Embodiment 2

Embodiment 2 is an example in which in the case where, in a multi-screen display mode in which the display panel 103 of the image display apparatus 100 is divided into a plurality of areas for display, image processing settings differ for each screen, the acquisition frequencies for the temperature sensors 105 are varied. Note that since the hardware configuration and the functional block configuration for realizing Embodiment 2 are same as those of Embodiment 1, description thereof is omitted here.

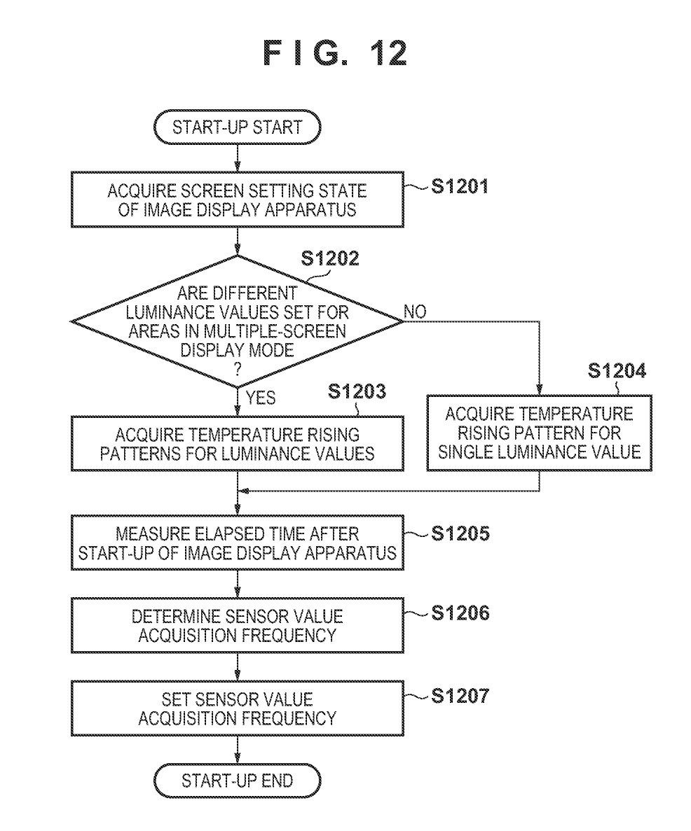

Processing in which the acquisition frequency determination unit 202 determines the sensor value acquisition frequency after start-up of an image display apparatus 100 in Embodiment 2 will be described with reference to FIG. 12.

In FIG. 12, after the image display apparatus 100 is started up, in step S1201, the information acquisition unit 203 reads out a variety of information of the image display apparatus 100. Here, the display panel 103 of the image display apparatus 100 is set to the multi-screen display mode, and information representing whether image processing applied to the screens is different is read out. Note that here, image processing refers to the setting of luminance values for each screen, namely, screen brightness.

In step S1202, the sensor value acquisition frequency determination unit 202 determines display setting of the image display apparatus 100 based on the information read out in step S1201. If the multi-screen display mode is set and the setting is such that the luminance values differ for each screen, the procedure proceeds to step S1203.

In step S1203, the information acquisition unit 203 acquires, from the storage medium 108, a temperature rising pattern with respect to the luminance values of each screen.

If it is determined in step S1202 that the same luminance value is set for the entire screen, the information acquisition unit 203 reads out, from the storage medium 108, a temperature rising pattern with respect to a single luminance value in step S1204.

In step S1205, the elapsed time after start-up of the image display apparatus 100 is measured by the timer 206.

In step S1206, the sensor value acquisition frequency determination unit 202 determines the sensor value acquisition frequency based on the elapsed time after start-up measured in step S1205 and the temperature rising pattern acquired in step S1203 or S1204.

Note that although in the present embodiment, the same sensor value acquisition frequency is used for the plurality of luminance sensors 104 and the plurality of temperature sensors 105, different acquisition frequencies may be used therefor. In addition, the frequency for acquiring sensor values from the plurality of luminance sensors 104 may be fixed, and the sensor value acquisition frequency determination unit 202 may determine only frequency for acquiring sensor values from the plurality of temperature sensors 105 mounted to the image display apparatus 100, based on a variety of information of the image display apparatus 100 and the elapsed time after start-up of the image display apparatus 100.

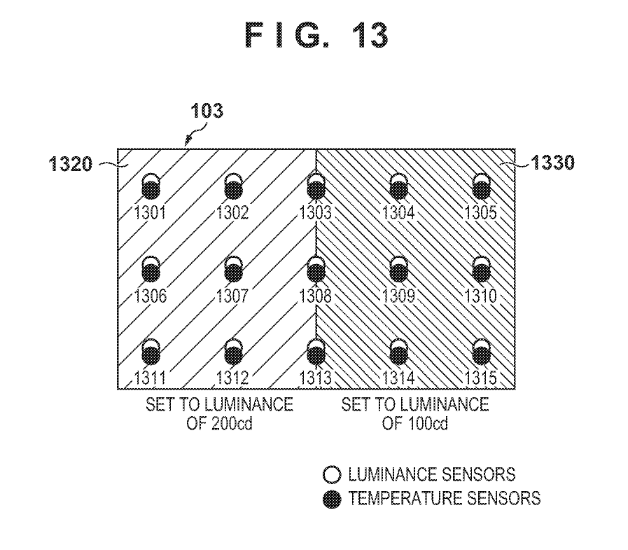

Here, processing for determining sensor value acquisition frequency performed in step S1206 will be described with reference to FIG. 13. Note that a case in which different luminance values are set for each screen in step S1202 will be described below. FIG. 13 schematically illustrates the layout of the luminance sensors 104 and the temperature sensors 105 in the display panel 103 at the multi-screen display mode. Fifteen each of the luminance sensors 104 and the temperature sensors 105 are arranged on the display panel 103. One each of the luminance sensor 104 and the temperature sensor 105 are arranged at the same position on the display panel 103, and the sets of sensors are arranged equally spaced at the portions indicated by 1301 to 1315 in FIG. 13. FIG. 13 shows a state in which the display is divided into two screens, and different luminance values are set for the area indicated by 1320 and the area indicated by 1330 in FIG. 13. A luminance value set for the area 1320 in FIG. 13 is higher than that set for the area 1330. Generally, the higher the luminance value set for the area, the more precipitously the temperature rises in the area, and the lower the luminance value set for the area, the more gently the temperature rises in the area. Accordingly, the temperature rises more precipitously in the area 1320 in FIG. 13 and the temperature rises more gently the area 1330.

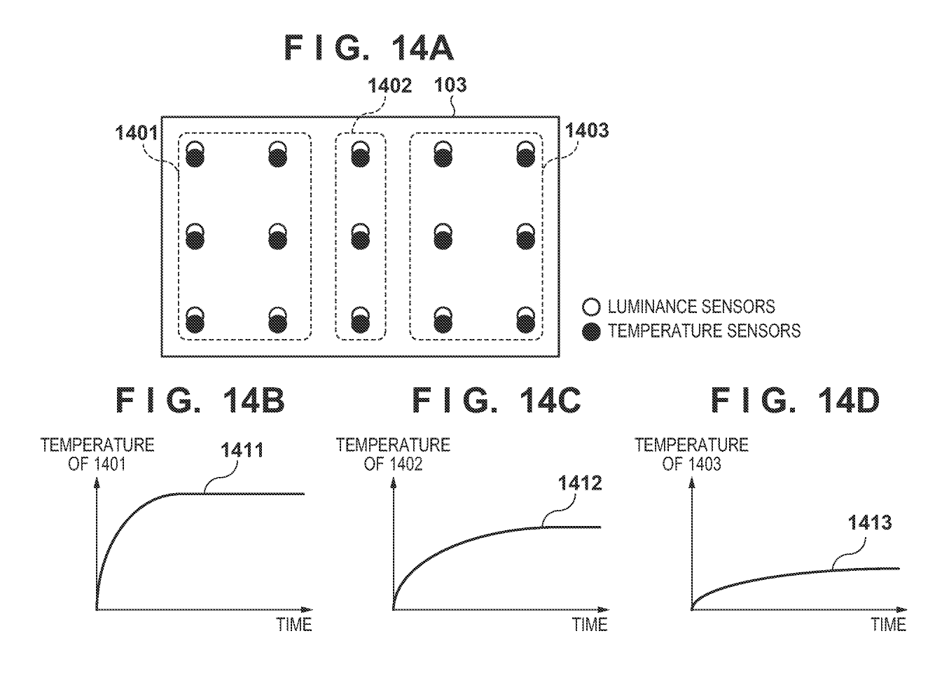

Next, temperature change inside the image display apparatus 100 will be described with reference to FIGS. 14A to 14D. FIGS. 14A to 14D illustrate temperature rising patterns of a plurality of areas inside the image display apparatus 100. As shown in FIG. 14A, the display panel 103 is divided into three areas, namely, an area 1401, an area 1402 and an area 1403, according to the temperature rising rate. The area 1401 is an area having the highest luminance value, where the temperature changes the most acutely. The area 1403 has the lowest luminance value, where the temperature changes the most gently. Temperature change in the area 1402 is between that in the area 1401 and that in the area 1403. The temperature rising patterns in the area 1401, the area 1402 and the area 1403 are respectively shown in a graph 1411, a graph 1412 and a graph 1413 of FIG. 14B to 14D. These temperature rising patterns are recorded in advance in the storage medium 108. Based on FIGS. 14A to 14D, it is possible, in the area 1401 where the temperature changes acutely, to accurately obtain the temperature corresponding to the elapsed time by setting a high sensor value acquisition frequency.

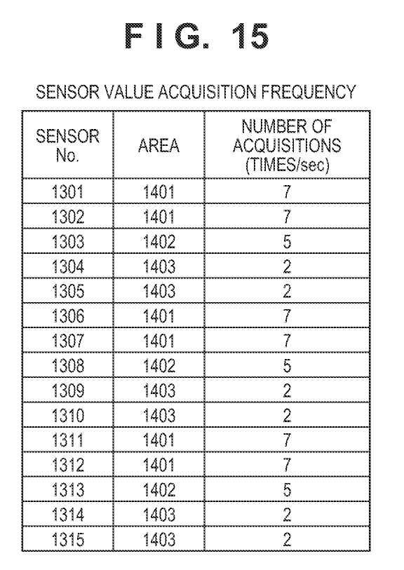

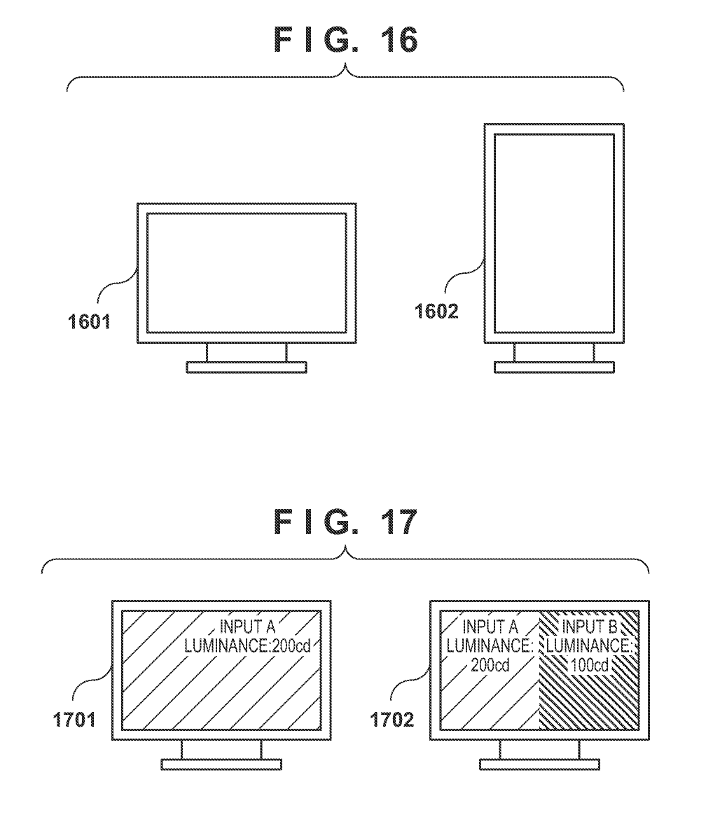

Then, the sensor value acquisition frequency determination unit 202 determines sensor value acquisition frequencies for the sensors based on the sensor value acquisition frequencies shown in FIG. 15. Processing for determining the acquisition frequency is similar to that described in Embodiment 1 with reference to FIGS. 6A to 6C. With the sensor value acquisition frequencies for the sensors shown in FIG. 15, the sensors belonging to the area 1401 in FIG. 14A have the highest number of sensor value acquisitions per unit time.

Description is given again with respect to FIG. 12. In step S1207, the acquisition frequencies determined in step S1206 are set in the sensor value acquisition control unit 201. The sensor value acquisition control unit 201 acquires sensor values from the luminance sensors 104 and the temperature sensors 105 according to the set acquisition frequencies.

In Embodiment 2 described above, it is possible to determine the sensor value acquisition frequency, while taking difference in the luminance value of each screen of the image display apparatus 100 in the multi-screen display mode into account, when the image display apparatus 100 is started up. In this manner, even if the luminance value differs for each screen of the image display apparatus 100, it is possible to constantly measure accurate temperature, which makes it possible to perform feedback control for displaying an image at an accurate luminance.

Note that processing performed for transitioning to the steady state and processing relating to the luminance correction feedback control in a normal state are similar to those of Embodiment 1 shown in FIGS. 10 and 11.

With Embodiment 2 described above, accurate temperature measurement becomes possible that takes change in temperature rising in the display panel 103 due to difference in the luminance values for each screen in the multi-screen display mode of the image display apparatus 100 into account. As a result, sensor values from the luminance sensors 104 can be corrected with high accuracy, and it becomes possible to perform appropriate feedback control on the luminance of the display panel 103.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-030219, filed Feb. 15, 2011, and No. 2011-289897, filed Dec. 28, 2011 which are hereby incorporated by reference herein in their entirety.

What is claimed is:

1. An image display apparatus, comprising:
a display unit;
a luminance sensor arranged in plural portions of the display unit, each luminance sensor having temperature characteristics;
a temperature sensor arranged in plural portions of the display unit;
an acquisition control unit configured to acquire a temperature value from the temperature sensor and a luminance value from the luminance sensor;
a determination unit configured to determine a frequency for acquiring the temperature value from the temperature sensor based on an orientation of the display unit or a display setting;
a correction unit configured to correct the luminance value acquired from the luminance sensor by using the temperature value acquired from the temperature sensor; and
an image processing unit configured to control luminance of the display unit by using the luminance value corrected by the correction unit as a target luminance value.

2. The apparatus according to claim 1, wherein the determination unit performs determination such that the acquisition frequency from a temperature sensor that is arranged in a predetermined position of the display unit differs between a case in which the display unit is in a portrait orientation and a case in which the display unit is in a landscape orientation.

3. The apparatus according to claim 1, wherein in a case where the display setting of the display unit is set to a multi-screen display mode in which the display unit is divided into a first area and a second area for display, the determination unit performs determination such that an acquisition frequency from a temperature sensor arranged in the first area differs from an acquisition frequency from a temperature sensor arranged in the second area.

4. The apparatus according to claim 1, further comprising:
an information acquisition unit configured to acquire information representing the orientation of the display unit, or information representing the display setting of the display unit,
wherein the determination unit determines an acquisition frequency for the temperature value acquired from the temperature sensor, based on the information acquired by the information acquisition unit.

5. The apparatus according to claim 4, wherein the determination unit determines the acquisition frequency according to a temperature rising pattern of the display unit that is preset according to the orientation of the display unit or the display setting, and an elapsed time after start-up of the image display apparatus.

6. The apparatus according to claim 4, wherein the determination unit sets the acquisition frequency from a temperature sensor arranged in an area in which a temperature rising rate of the display unit is greater than that of another area to a higher value.

7. The apparatus according to claim 1, wherein the temperature sensor and the luminance sensor are arranged equally spaced at plural portions, one each of the temperature sensor and the luminance sensor being arranged in the same position of the display unit.

8. The apparatus according to claim 1, wherein the determination unit further determines an acquisition frequency for the luminance value acquired from the luminance sensor, and performs determination such that the acquisition frequency for the temperature value acquired from the temperature sensor is the same as the acquisition frequency for the luminance value acquired from the luminance sensor.

9. A control method of an image display apparatus having a display unit, a luminance sensor arranged in plural portions of the display unit, each luminance sensor having temperature characteristics, and a temperature sensor arranged in plural portions of the display unit, the method comprising the steps of:
acquiring a temperature value from the temperature sensor and acquire a luminance value from the luminance sensor;
determining a frequency for acquiring the temperature value from the temperature sensor based on an orientation of the display unit or a display setting;
correcting the luminance value acquired from the luminance sensor by using the temperature value acquired from the temperature sensor; and
controlling luminance of the display unit by using the luminance value corrected in the correcting step as a target luminance value.

10. A computer-readable storage medium storing a program for causing a computer to execute the control method of the image display apparatus according to claim 9.
